(19) United States
(12) Patent Application Publication
(10) Pub. No.: US 2016/0219193 A1
(43) Pub. Date: Jul. 28, 2016

(54) VIDEO INSPECTION DEVICE

(71) Applicant: Inspectron, Inc., Novi, MI (US)

(72) Inventors: Richard Price, Commerce Township, MI (US); Tye L. Newman, Howell, MI (US); Brent F. Lyons, Howell, MI (US)

(21) Appl. No.: 15/003,894

(22) Filed: Jan. 22, 2016

Related U.S. Application Data
(60) Provisional application No. 62/107,044, filed on Jan. 23, 2015.

(51) Int. Cl. H04N 5/225; H04N 5/247; H04N 5/77; H04N 7/18

(52) U.S. Cl. CPC H04N 5/2251; H04N 7/18; H04N 5/247; H04N 5/77; H04N 2005/2255

(57) ABSTRACT

A video inspection device is provided. The video inspection device may have a base unit and a video imaging attachment. The video imaging attachment may include configuration information stored in the attachment and may communicate the configuration information to the base unit.

### CROSS REFERENCE TO RELATED APPLICATIONS

This application claims the benefit of U.S. Provisional Patent Application No. 62/107,044 filed Jan. 23, 2015, the content of which is hereby incorporated by reference in its entirety.

### BACKGROUND

### 1. Field of the Invention

The present invention generally relates to a video inspection device.

### SUMMARY

A video inspection device is provided. The video inspection device may have a base unit and a video imaging attachment. The video imaging attachment may include configuration information stored in the attachment and may communicate the configuration information to the base unit.

Further objects, features and advantages of this disclosure will become readily apparent to persons skilled in the art after a review of the following description, with reference to the drawings and claims that are appended to and form a part of this specification.

### BRIEF DESCRIPTION OF THE DRAWINGS

FIG. 1 is a block diagram illustrating a video inspection device.

FIG. 2 is a block diagram of one implementation of the video inspection device from FIG. 1.

FIG. 3 is a block diagram of another implementation of the video inspection device from FIG. 1.

FIG. 4 is an illustration of a user interface for selecting an imager mode.

### DETAILED DESCRIPTION

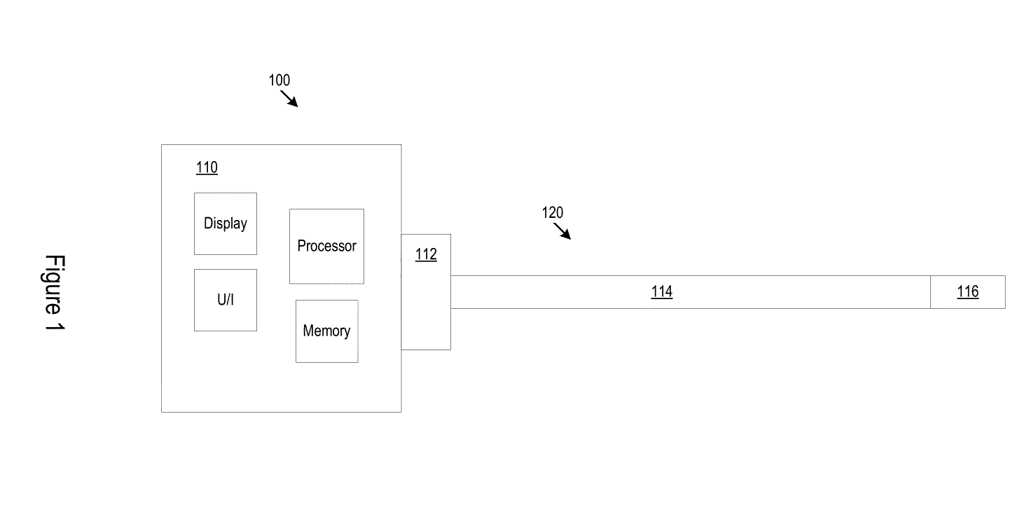

FIG. 1 illustrates a video inspection device 100. The video inspection device 100 includes a hand-held base unit 110. The hand-held base unit 110 includes a display for displaying video as well as graphics and user interface information. The base unit 110 may also include a user interface including buttons, sliders and other controls. The user interface controls can be integrated into the display, for example, using a touch screen interface. The base unit 110 may include a processor and a memory. The processor may be used for processing video data prior to display on the display. The processor may also be used for controlling the user interface and receiving user input. The processor may also communicate with the video attachment device 120. The video attachment device 120 may include a connector 112, an arm 114, and a sensor head 116.

The processor and the base unit 110 may communicate with the video attachment device 120 to configure various aspects of the video attachment device as will be described in more detail below. The processor and the base unit 110 may communicate with a memory in the base unit. The memory may be used for processing video data, storing base unit configuration information for the running of the display, user interface, or processor; or for storing configuration information related to the video attachment device 120.

In some instances, the video attachment device 120 includes a sensing head 116 to include one or more image sensors in various configurations. In addition, the sensing head 116 may include various light sources, for example LEDs, that are configured to illuminate the viewing area of the imaging sensors contained within the sensing head 116. The sensing head 116 may include a microprocessor configured to control the configuration of the image sensors and/or the lighting contained in the sensing head 116. The arm 114 may be connected between the connector 112 and the sensing head 116 and provide a protected passageway for wires and/or signals that are communicated between the sensing head 116 and the connector 112, as well as, the base unit 110. The arm 114 may be a flexible tube allowing the sensing head to be positioned in various hard to reach places while protecting any wires or communication between the sensing head and the rest of the device from mechanical and/or electrical interference or obstruction.

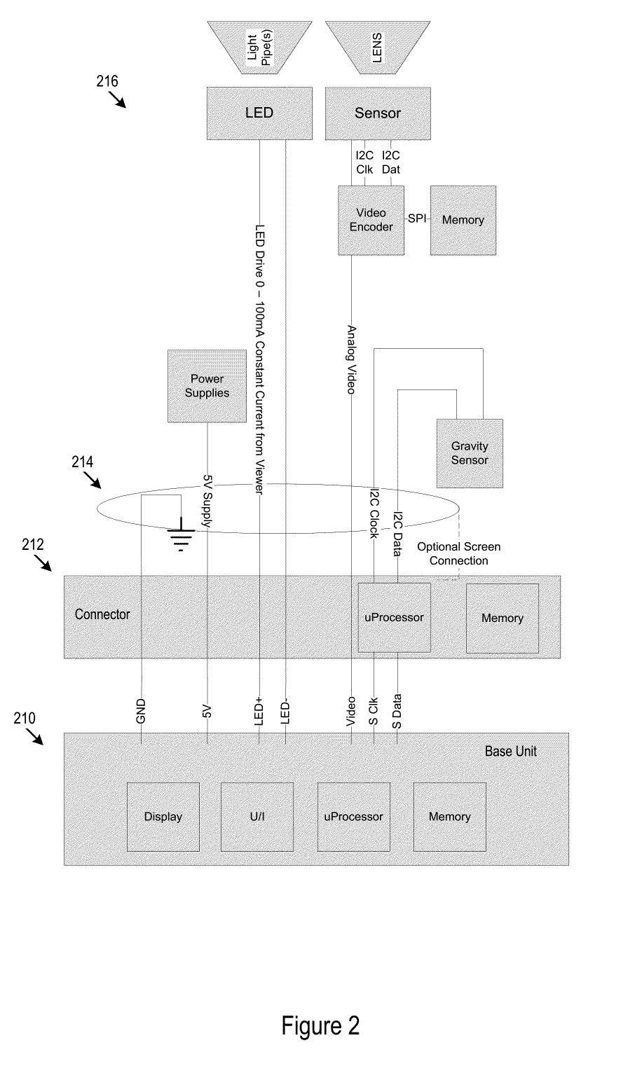

FIG. 2 is an illustration of one implementation of an inspection device. As shown in FIG. 1, the base unit 210 includes a display, a user interface, a processor, and a memory. The base unit is connected to a connector 212 with the video attachment device. The connector 212 is connected to the imaging head 216 by flexible arm 214. In this implementation, the connector 212 includes a microprocessor and a memory. The microprocessor and memory include information about the video attachment device, for example information regarding the capabilities of the video attachment device. For example, the memory may include information such as an unique attachment ID, a serial number, a model number, the number of sensors, the type of sensors, the orientation of the sensors, the type of lighting, power requirements for the lighting, orientation of the lighting, calibration information for the gravity sensor, calibration information for the imaging sensors, the length of the arm, the size of the sensor head (e.g., diameter, width, length) as well as any other physical characteristics or functional capabilities of the attachment device.

The microprocessor and connector 212 may communicate with the microprocessor and the base unit 210 to inform the base unit about the functional capabilities and/or physical characteristics of the video attachment device 212. The communication between the processor 212 and the connector and the processor 210 and the base unit may also include security information, for example, to identify and or verify the licensing of certain software that may be required to utilize certain functions of the video attachment device. Accordingly, the microprocessor in the connector 212 may enable or disable one or more functions of the video attachment device based on licensing information communicated or verified by the microprocessor and the base unit 210.

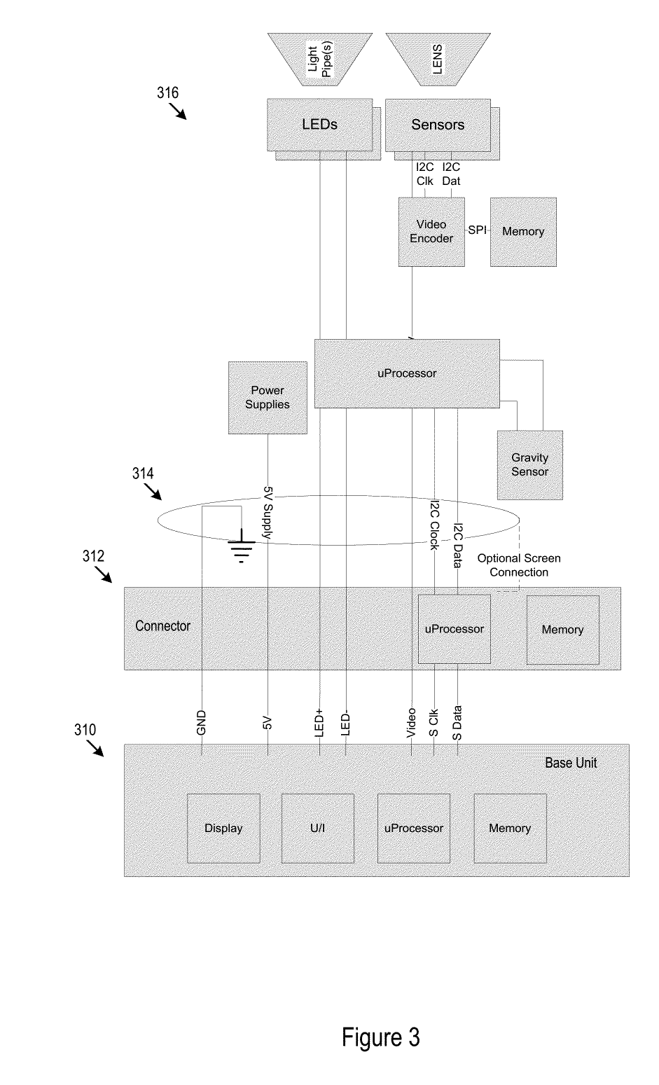

FIG. 3 is an illustration of another implementation of an inspection device. As shown in FIG. 1, the base unit 310 includes a display, a user interface, a processor, and a memory. The base unit is connected to a connector 312 with the video attachment device. The connector 312 is connected to the imaging head 316 by flexible arm 314. In this implementation, the imaging head 316 includes a microprocessor and a memory. The microprocessor and memory include information about the video attachment device, for example information regarding the capabilities of the video attachment device. For example, the memory may include information such as an unique attachment ID, a serial number, a model number, the number of sensors, the type of sensors, the orientation of the sensors, the type of lighting, power requirements for the lighting, orientation of the lighting, calibration information for the gravity sensor, calibration information for the imaging sensors, the length of the arm, the size of the sensor head (e.g., diameter, width, length) as well as any other physical characteristics or functional capabilities of the attachment device. In addition, the connector 312 may also include a connector as described above with respect to FIG. 2.

The either one or both of microprocessor in the connector 312 and the microprocessor in the sensing head 316 may communicate with the microprocessor and the base unit 310 to inform the base unit about the functional capabilities and/or physical characteristics of the video attachment device. The communication between the processor in the sensing head 316 and the processor in the base unit 310 may also include security information, for example, to identify and or verify the licensing of certain software that may be required to utilize certain functions of the video attachment device. Accordingly, the microprocessor in the sensing head 316 may enable or disable one or more functions of the video attachment device based on licensing information communicated or verified by the microprocessor and the base unit 310.

In some instances, the processor in the sensing head 316 may communicate with the processor in the connector 312. The processor in the sensing head 316 may communicate with the processor in the connector 312 to execute functions commanded by the processor in the connector 312 based on the information received by the processor in the connector 312 from the processor in the base unit 310. The processor in the sensing head 316 may also communicate with the processor in the connector 312 to pass on information received by the processor in the connector 312 from the processor in the base unit 310. In these instances, the processor in the sensing head 316 may determine to take actions based directly on the information provided by the processor in the base unit 310.

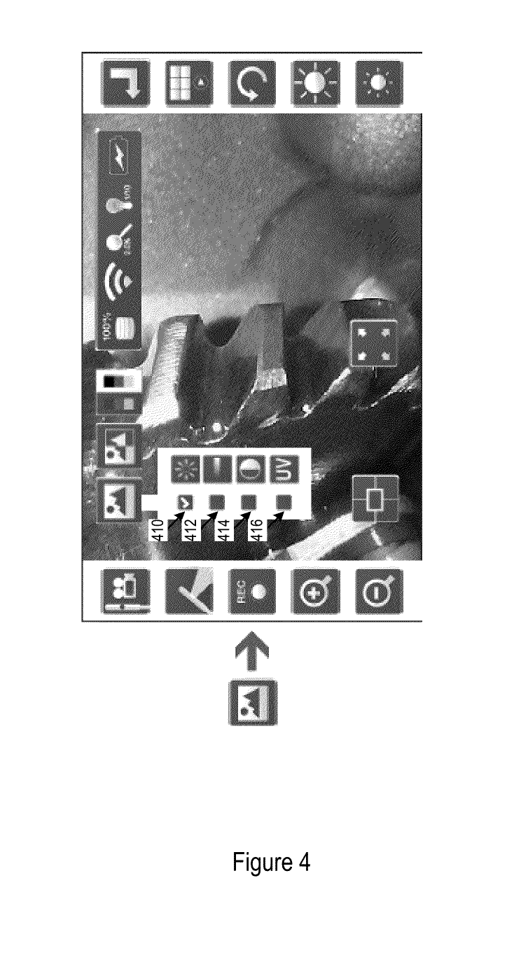

Now referring to FIG. 4, the user interface of the base module may include controls to select various modes of operation for the video attachment device. The modes may include modes such as brightness 410, contrast 412, black and white 414, or UV (ultra-violet) 416. Although many other modes are contemplated and may adjust how a sensor renders the color palette, exposure, the amount of red, green and blue, contrast, inversion of the image, selection between color black and white, etc.

Each mode may have corresponding sensor settings (gain, baseline, threshold, color palette adjustment), lighting settings (which lights, lighting power, lighting type-white-US), gravitational sensor (offset, enable), or other configuration details.

In addition, certain application specific software on the base unit may be enable, disabled, or configured based on the information provided by the processors in the imaging attachment. For example, an application that is designed for UV or IR (infra-red) analysis by be disabled or made not available to the user if the imaging attachment indicates that it does not support UV or IR imaging. In other application specific software on the base unit may modify the options or menu interface available to the user based on the information provided from the processors in the imaging attachment.

One example method for configuring the imaging device based on the information stored in the attachment is provided below.
a. Identifies particular imager configuration—Unique to each imager type
b. Identifies imaging unit attached via imager ID from lookup table in the base unit, connector, or imaging head
   i. Pre-configured settings for each imager type—register table in software for each imager ID
      1. LED driver configuration
      2. Image sensor configuration table
   ii. Settings adjusted based on a known number categories
      1. Single or dual view (forward/side)
      2. Digital/Analog
      3. Length—ID

In other methods, all of the characteristics and functionality of the attachment device may be accessed and/or communicated individually between the base unit and the attachment. The information available may include but is not limited to the information in the table below, as well as, the information provided elsewhere in this application.

| Command | Detail |
|---|---|
| MASTERBUSY | 1 = busy, 0 = idle |
| GSENSOR | 1 = product has a g- |
| | sensor, 0 = product |
| | does not have a g- |
| | sensor |
| NUMBER_OF_LEDS | Returns number of |
| | LEDs in imager |
| | accessory |
| NUMBER_OF_CMOS_IMAGERS | Returns number of |
| | CMOS imagers within |
| | imager accessory |
| VIDEO_OUTPUT_FORMAT | 0 = LVDS, 1 = NTSC, |
| | 2 = PAL |
| MAX_LED_CURRENT | Returns maximum |
| | current to imager LEDs |
| | in mA |
| MIN_LED_CURRENT | Returns minimum |
| | current to imager LEDs |
| | in mA (This is the |
| | lowest current that is |
| | required to be passed |
| | through the LED in |
| | order that a human can |
| | detect a glow from the |
| | LED) |
| CONFIGURE_CMOS_CAMERA | Write 1 to configure the |
| | currently selected |
| | CMOS camera |
| CMOS_CAMERA_CONFIGUERED | 0 = not configured, 1 = |
| | configured |
| SELECT_CMOS_IMAGER | 0 = select front view |
| | imager, 1 = select side |
| | view imager |
| SELECT_IMAGER_LED | 0 = select front view |
| | LEDs, 1 = select side |
| | view LEDs |
| MONOCHROME_SELECT | 0 = monochrome |
| | image disabled, 1 = |
| | monochrome image |
| | enabled |
| IMAGE_FLIP_SELECT | 0 = image flip disabled, |
| | 1 = image flip enabled |
| IMAGE_MIRROR_SELECT | 0 = image mirror |
| | disabled, 1 = image |
| | mirror enabled |
| GSENSOR_ANGLE_HIBYTE | Returns the upper bits |
| | of the angle read from |
| | the g-sensor |
| GSENSOR_ANGLE_LOBYTE | Returns the lower 8- |
| | bits of the angle read |
| | from the g-sensor |
| Flash | On/Off |
| Effect | Warm/Cool/None. |
| Scene Mode | Low light/Demo/Bright |
| | or shiny metal/ |
| | Fireworks |
| Exposure Value | −2.0 to +2.0 |
| Metering | Matrix/Center |
| | Weighted/Spot |
| Timer | Off/2 sec/5 sec/10 sec |
| Resolution | 320 × 240/640 × 480/ |
| | 720 × 480/1280 × |
| | 960 |
| White Balance | Auto/Day light/ |
| | Cloudy/ |
| | lncandesecent/ |
| | Flourescent |
| ISO | Auto/100/200/400/ |
| | 800 |

The image sensor may provide other standard functions to the viewer. These settings/functions may be accessed via an I2C protocol.

On Power-On the processor in the imager connector may be in I2C SLAVE mode until a command from the base unit instructs the microprocessor to configure the sensor. At this point, the viewer may release the I2C bus and the imager microprocessor in the sensing head may become the host and configure the sensor. After completing the configuration, the microprocessor may set a flag then return to SLAVE mode. The processor in the base unit may operate in I2C slave mode and may support I2C read and write.

The sensor(s) in the sensing head may be configured locally by a processor with supporting FLASH memory. The gravity sensor may be interpreted by the processor in the connector. The processor in the connector may also provide full support for the I2C protocol as described in this document to aid in compatibility of future attachments.

The design provided allows new imagers to be added to the base unit after launch. Further, the ability to adjust for part obsolescence is also improved. The items to consider include:
Use of a standard connector
Gravity sensor support
LED drive
Single and Dual View imager support

Using this design, each of these items may be revised without an update to the hardware or firmware of the base units that are in the field to enable them to work with the new or updated imaging attachments.

The connector may use a standard USB3 connector interface and custom plastics to create a unique, rugged, and low cost alternative to the standard aluminum connectors system used on many boroscopes today.

The imaging attachment may have a gravity sensor to allow the system to display an UP indicator or to rotate the image to provide an Up is Up function. The gravity (G) sensor may interface to the processor in the connector of the imaging attachment. The processor in the connector may translate the G Sensor output into a simple angular number—this may allow for future changes to the G sensor without updating the base unit software.

The attachment may have a single, high power LED. However, the driver may be capable of being controlled in multiple steps from zero to a maximum current determined by reading the appropriate I2C address in the imaging attachment. If in the future, a smaller imager attachment with an LED that requires a much smaller LED current, it can be driven from off to full on without damage. Both the Anode and Cathode of the LED may be connected directly back to the base unit. This type of design allows for a low-cost LED driver to be used that is capable of supporting multiple LEDs and differing LED types. Although, it is also contemplated that the processor in the sensing head may also control the LED configuration.

Some imaging attachments may provide a dual view imager functionality. A mechanism may be provided for the system to select the camera image that is displayed. The selection may be done using a physical switch on the connecter. However, the processor may allow the user to select the camera using the viewer unit user interface. Using the processor may be a more convenient and reliable method. Provision may be made in the system architecture and base unit implementation to support dual view imagers. However this is implemented, the switching of the LED and sensor may be done by the imager assembly and controlled by a simple I2C command from the base unit.

To prevent damage to the imager attachments or base units from using, some implementation may only utilize the following pins on the USB3 connector on both the imager attachment and base units to be connected. All other pins may be no-connect pins.
+5V
GND
Video In
I2C Clock
I2C Data
LED+
LED−

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of the principles of this disclosure. This description is not intended to limit the scope or application of this disclosure in that the systems and methods are susceptible to modification, variation and change, without departing from spirit of this disclosure, as defined in the following claims.

We claim:

1. A video inspection attachment configured to connect with a base unit, the video inspection attachment comprising:
a sensing head;
a memory including configuration information of the sensing head, wherein the video inspection attachment is configured to communicate the configuration information with the base unit.

2. The video inspection attachment of claim 1, wherein the sensing head is located at a distal end of a flexible arm and the memory is located in a connector at the proximal end of the flexible arm.

3. The video inspection attachment of claim 2, wherein the memory includes at least one of an unique attachment ID, a serial number, a model number, the number of sensors, the type of sensors.

4. The video inspection attachment of claim 2, wherein the memory includes at least one of the orientation of sensors, type of lighting, power requirements for the lighting, orientation of the lighting, calibration information for a gravity sensor, calibration information for imaging sensors, length of the arm, size of the sensing head.

5. The video inspection attachment of claim 2, wherein the memory includes a unique attachment ID, a serial number, a model number, the number of sensors, the type of sensors, the orientation of the sensors, type of lighting, power requirements for the lighting, orientation of the lighting, calibration information for a gravity sensor, calibration information for imaging sensors, length of the arm, the size of the sensing head.

6. A video inspection attachment configured to connect with a base unit, the video inspection attachment comprising:
a connector configured to removably attach the video inspection attachment to the base unit;
an arm extending from the connector;
a sensing head including at least one imaging sensor attached to a distal end of the arm;
a memory including configuration information of the sensing head;
a processor communicate the configuration information with the base unit.

7. The video inspection attachment of claim 6, wherein the processor is located in the connector at a proximal end of the arm.

8. The video inspection attachment of claim 6, wherein the memory includes at least one of an unique attachment ID, a serial number, a model number, the number of sensors, the type of sensors.

9. The video inspection attachment of claim 6, wherein the memory includes at least one of the orientation of sensors, type of lighting, power requirements for the lighting, orientation of the lighting, calibration information for a gravity sensor, calibration information for imaging sensors, length of the arm, size of the sensing head.

10. A video inspection device comprising:
a base unit including a display and a user interface;
a video inspection attachment, the video inspection attachment comprising:
a sensing head;
a memory including configuration information of the sensing head, wherein the video inspection attachment is configured to communicate the configuration information with the base unit.

11. The video inspection device of claim 10, wherein the sensing head is located at a distal end of a flexible arm and the memory is located in a connector at the proximal end of the flexible arm.

12. The video inspection device of claim 10, wherein the memory includes at least one of an unique attachment ID, a serial number, a model number, the number of sensors, the type of sensors.

13. The video inspection device of claim 10, wherein the memory includes at least one of the orientation of sensors, type of lighting, power requirements for the lighting, orientation of the lighting, calibration information for a gravity sensor, calibration information for imaging sensors, length of the arm, size of the sensing head.

14. The video inspection device of claim 10, further comprising a first processor in the base unit and a second processor in the video inspection attachment that communicate configuration information over a communication bus.

15. The video inspection device of claim 14, wherein the first processor initiates communication as a bus master with the second processor during power on, then the second processor becoming the bus master to communicate the configuration information to the base unit.

16. The video inspection device of claim 14, wherein the first processor includes security information that verifies the licensing of certain software required to utilize certain functions of the video attachment device.

17. The video inspection device of claim 16, wherein the second processor may disable one or more functions of the video attachment device in response to the security information.

18. The video inspection device of claim 14, wherein the first processor may enable gravity indication mode based on the second processor providing gravity sensor information.

19. The video inspection device of claim 14, wherein the first processor may enable UV or IR sensing mode based on the second processor providing UV or IR sensor information.

20. The video inspection device of claim 14, wherein the first processor may enable multi-view sensing mode based on the second processor providing information regarding a number of sensors.
